(19) United States
(12) Patent Application Publication
(10) Pub. No.: US 2003/0175550 A1
(43) Pub. Date: Sep. 18, 2003

(54) ELECTRICALLY CONDUCTIVE METAL STRIP AND PLUG CONNECTOR MADE THEREFROM

(76) Inventors: ALBERT RUMBACH, AACHEN (DE); UDO ADLER, STOLBERG (DE)

Correspondence Address: KENYON & KENYON, ONE BROADWAY, NEW YORK, NY, 10004, US

(21) Appl. No.: 09/196,916

(22) Filed: Nov. 20, 1998

(30) Foreign Application Priority Data
Nov. 22, 1997 (DE) 197 51 841.9

(51) Int. Cl. H01B 1/02; H01R 13/02; H01H 1/02; C22C 9/04; C22C 9/06

(52) U.S. Cl. 428/675; 428/929; 200/266; 200/267; 439/887; 439/886; 439/931; 420/481

(57) ABSTRACT

An electrically conductive metal strip for the production of electrical contact components, in particular plug connectors, having a core strip made of a copper material and a metal facing, made of a copper-nickel-zinc alloy (nickel silver), roll-bonded clad on at least one side. The core strip possesses an electrical conductivity of at least 20 mΩ/mm². The combination of copper material and nickel silver as the metal facing yields a metal strip with high electrical conductivity whose mechanical surface properties correspond to those of nickel silver.

### BACKGROUND OF THE INVENTION

1. Field of the Invention

The invention relates to an electrically conductive metal strip for the production of electrical contact components, and a plug connector.

2. Description of Related Art

Strips made from copper material with coatings made from various metals or metal alloys are widely used in the electronic and electrical industry, for economic and technical reasons, in the production of mass-produced parts. For example, connector terminals, conductive paths, or plug connectors in various forms, as well as other connecting parts, are made from a precursor material of this kind.

Copper materials are used in this context because of their high electrical conductivity. For protection against corrosion and wear and in order to increase surface hardness, the copper material is equipped with a metallic coating, tin generally being used as the coating metal. An electroplated coating, or application of the coating with the hot-dip method, is usual.

High technical and quality requirements are applied in general to the electrical contact components, especially in terms of mechanical and electrical properties. This applies in particular when the contact components are used under difficult or aggressive environmental conditions, for example for plug connectors in motor vehicle electrical systems, and there principally in engine electronics.

Under difficult environmental conditions of this kind, requirements may arise, especially in terms of temperature or relaxation strength and corrosion resistance, which can no longer be met (or can be met to only a limited extent) by electrical contact components of known configuration. For example, the use of known coating materials such as tin, silver, or gold and their alloys reaches its limit at a maximum temperature of 150° C.

### SUMMARY OF THE INVENTION

It is therefore an object of the invention to make available an electrically conductive metal strip for the production of electrical contact components, in particular of plug connectors, having high temperature and relaxation strength, abrasion resistance, and hardness, along with good formability and ductility. In accordance with the invention, these and other objects are achieved by an electrically conductive metal strip for the production of electrical contact components, in particular plug connectors, having a core strip made of a copper material and a metal facing, made of a copper-nickel-zinc alloy (nickel silver), roll-bonded clad on at least one side. The core strip preferably possesses an electrical conductivity of at least 20 mΩ/mm². The combination of copper material and nickel silver as the metal facing yields a metal strip with high electrical conductivity whose mechanical surface properties correspond to those of nickel silver.

### DETAILED DESCRIPTION OF THE INVENTION

The electrically conductive metal strip of the invention is a combination of a core strip consisting of a copper material, and a metal facing made of a copper-nickel-zinc alloy (nickel silver) applied by roll-bonded cladding on at least one side.

The use of a copper material for the core strip guarantees very good, high electrical conductivity. In combination with nickel silver, which by way of the roll-bonded clad layer yields an intimate bond with the core strip, the result is to ensure high-temperature strength for the metal strip even above 150° C., as well as good abrasion resistance and hardness, while guaranteeing good formability, ductility, and spring characteristics. With contact components manufactured from the metal strip according to the present invention, the risk of fretting corrosion is also reduced.

The core strip is preferably made of a material having an electrical conductivity of at least 20 mΩ/mm².

This can, for example, be a low-alloyed copper material, copper-iron alloys, or pure copper. The chemical composition of materials that are particularly well-suited in practice as the material for the core strip is summarized in Table 1 below.

TABLE 1
Core strip materials

| Alloy | CU % | Fe % | P % | Zn % | Sn % | Mg % | Ni % | Si % | Ag % |
|---|---|---|---|---|---|---|---|---|---|
| A | Reminder | | 0.010-0.100 | | | | 0.80-1.80 | 0.15-0.35 | |
| B | min. 99.2 | | 0.002-0.120 | | 0.050-0.30 | 0.050-0.150 | | | 0.010-0.10 |
| C | min. 99.0 | | max. 0.10 | | | 0.400-0.800 | | | |
| D | min. 97.0 | 2.10-2.60 | 0.015-0.150 | 0.050-0.200 | | max. 0.100 | | | |
| E | Reminder | | | | 0.15-0.25 | | | | |
| F | Reminder | | | 0.5-1.5 | 0.2-0.8 | | 1.3-27 | 0.2-0.8 | |
| G | Reminder | 2.10-2.60 | 0.015-0.040 | max. 0.25 | max. 0.1 | max. 0.1 | max 0.1 | max. 0.1 | max. 0.1 |

The electrical conductivity of these core strip materials lies between 23 mΩ/mm² and 45 mΩ/mm².

Particularly advantageous materials for the metal facing have the chemical composition indicated in Table 2.

TABLE 2
Cladding materials

| Alloy | Cu % | Ni % | Zn % | Sn % | Fe % | Other |
|---|---|---|---|---|---|---|
| CuNi18Zn27 | 53.50- | 16.50- | Reminder | max. | max. | max. |
| | 56.50 | 19.50 | | 0.2 | 0.3 | 0.5 |
| CuNi18Zn20 | 60.00- | 17.00- | Reminder | max. | max. | max. |
| | 63.00 | 19.00 | | 0.2 | 0.3 | 0.5 |
| CuNi12Zn24 | 63.00- | 11.00- | Reminder | max. | max. | max. |
| | 66.00 | 13.00 | | 0.2 | 0.3 | 0.5 |

The metal facing is manufactured by roll-bonded cladding, preferably by cold roll-bonded cladding. The metallic bond between core strip and metal facing ensures a reliable electrical contact with good heat conduction at the join, along with precise dimensional accuracy.

Theoretically, cladding of the core strip can be performed on one side or on both sides. With double-sided cladding, it is also possible to apply different materials onto the two sides of the core strip.

The facings are applied in various thicknesses depending on stress and strength.

Roll-bonding is accomplished, in known fashion, with the addition of a roll-bonding emulsion. The surface of the core strip is roughened prior to cladding. This can be accomplished by brushing, blasting, or pickling. Following roll-bonded cladding, the metal strip is heat-treated. Attainment of a continuous, permanently adhering coating is enhanced in particular by additional diffusion annealing.

The thickness of the metal facing is preferably between 3 and 10% of the total thickness of the metal strip.

It is thereby possible to create a metal strip which behaves, in terms of surface properties, corrosion and tarnish resistance, and abrasion resistance, like a solid strip of nickel silver, but possesses a substantially higher electrical conductivity. In addition, the metal strip according to the present invention has a very high temperature resistance of more than 150° C. Practical tests have shown that the relaxation strength and spring properties are very good even after extended static or dynamic loading.

A high-quality and cost-effectively achievable metal strip can be arrived at by using a core strip having a thickness of 3 to 4 mm, which is coated with a clad strip of nickel silver having a strip thickness of 0.15 to 0.20 mm. After roll-bonded cladding, the metal strip has a total thickness of between 0.10 and 1.5 mm, depending on how much it is rolled down.

Especially in the case of electrical plug connectors made from the metal strip according to the present invention, the range of applications can be expanded via the improvement in high-temperature strength in combination with the good mechanical and electrical properties of the composite material. Plug connectors of this kind are capable of reliably and repeatedly making and breaking an electrical connection over a long period of time and under existing mechanical, electrical and climatic ambient conditions.

What is claimed is:

1. An electrically conductive metal strip for the production of electrical contact components, comprising: a core strip made of a copper material; and a metal facing, made of a copper-nickel-zinc alloy, roll-bonded clad on at least one side thereof.

2. The metal strip as defined in claim 1, wherein the core strip possesses an electrical conductivity of at least 20 mΩ/mm².

3. The metal strip as defined in claim 1, wherein the metal facing consists of CuNi18Zn27.

4. The metal strip as defined in claim 2, wherein the metal facing consists of CuNi18Zn27.

5. The metal strip as defined in claim 1, wherein the metal facing consists of CuNi18Zn20.

6. The metal strip as defined in claim 2, wherein the metal facing consists of CuNi18Zn20.

7. The metal strip as defined in claim 1, wherein the metal facing consists of CuNi12Zn24.

8. The metal strip as defined in claim 2, wherein the metal facing consists of CuNi12Zn24.

9. The metal strip as defined in claim 1, wherein the thickness of the metal facing is 3% to 10% of the total thickness of the strip.

10. The metal strip as defined in claim 2, wherein the thickness of the metal facing is 3% to 10% of the total thickness of the strip.

11. The metal strip as defined in claim 3, wherein the thickness of the metal facing is 3% to 10% of the total thickness of the strip.

12. The metal strip as defined in claim 4, wherein the thickness of the metal facing is 3% to 10% of the total thickness of the strip.

13. The metal strip as defined in claim 5, wherein the thickness of the metal facing is 3% to 10% of the total thickness of the strip.

14. The metal strip as defined in claim 6, wherein the thickness of the metal facing is 3% to 10% of the total thickness of the strip.

15. The metal strip as defined in claim 7, wherein the thickness of the metal facing is 3% to 10% of the total thickness of the strip.

16. The metal strip as defined in claim 8, wherein the thickness of the metal facing is 3% to 10% of the total thickness of the strip.

17. A plug connector comprising the metal strip as defined in claim 1.
